(19) United States
(12) Patent Application Publication
(10) Pub. No.: US 2026/0210760 A1
(43) Pub. Date: Jul. 23, 2026

(54) SPECTROMETER FOR THE SPECTRAL ANALYSIS OF A SPECIMEN

(71) Applicant: CARL ZEISS SPECTROSCOPY GMBH, Jena (DE)

(72) Inventors: Michael BARTH, Jena (DE); Ralf-Peter GÜNTHER, Jena (DE); Karsten LINDIG, Jena (DE); Günter RUDOLPH, Jena (DE); Sebastian TANNERT, Jena (DE); Steffen WAGNER, Jena (DE)

(21) Appl. No.: 19/139,144

(22) PCT Filed: Dec. 13, 2023
(86) PCT No.: PCT/EP2023/085480

§ 371 Date: Jun. 13, 2025

(30) Foreign Application Priority Data
Dec. 22, 2022 (DE) 10 2022 134 456.8

(51) Int. Cl. G01J 3/02; G01J 3/10; G01J 3/18

(52) U.S. Cl. CPC G01J 3/021; G01J 3/0208; G01J 3/0291; G01J 3/10; G01J 3/18

(57) ABSTRACT

A spectrometer includes a radiation source for irradiating a sample with electromagnetic radiation, a dispersive element for spatiospectral splitting of the electromagnetic radiation reflected by the sample,-and a measurement window for transmitting the electromagnetic radiation generated by the radiation source to the sample and for transmitting the electromagnetic radiation reflected by the sample to the dispersive element. The electromagnetic radiation generated by the radiation source passes on a first inner beam path from the radiation source to the measurement window-and the electromagnetic radiation reflected by the sample passes on a second inner beam path from the measurement window to the dispersive element. The spectrometer also includes a spatially resolving detector for the wavelength-dependent conversion of the spatiospectrally split electromagnetic radiation. A deflection mirror is arranged on the first and second inner beam path for jointly deflecting the first inner beam path and the second inner beam path.

### CROSS-REFERENCE TO RELATED APPLICATION

This application is a 371 National phase of PCT/EP2023/085480, filed Dec. 13, 2023 and claims the benefit of German Application No. 10 2022 134 456.8, filed Dec. 22, 2022, the contents of which are incorporated herein by reference.

### BACKGROUND OF THE INVENTION

The present invention relates to a spectrometer for the spectral analysis of a sample. The spectrometer comprises a measurement window for transmitting electromagnetic radiation from a radiation source to the sample and for transmitting the electromagnetic radiation reflected by the sample to a dispersive element for the spatiospectral splitting of the electromagnetic radiation reflected by the sample. For example, the spectrometer is configured for the analysis of constituents of agricultural products or foodstuffs, for which purpose it is arranged on a harvester, for example.

The prior art discloses spectrometers for inline and atline process metrology for agricultural and food applications. Moisture values and constituents can be directly measured on the basis of NIR spectroscopy and associated calibrations. Such spectrometers can be used in a stationary or mobile fashion. Since NIR spectroscopy is an optical measurement method, the measurement accuracy essentially depends on the individual components of the spectrometer and the measurement arrangement that interfaces with the sample. The measurement window can become dirty and scratched during its useful life. If such a spectrometer is used on a forage harvester, for example, in extreme cases protective flanges are worn away by the material flow and need to be replaced. This means that there will be changes in measurement performance over the entire period of use. Aging phenomena, such as of a light source formed by a halogen lamp, for example, also have an influence on the measurement. To keep these changes within a defined tolerance range, the spectrometer has to be readjusted by a cyclic recalibration. During the manufacture of such spectrometers, a grayscale standard set is usually used to verify the linearity of the spectrometer. However, mirrors, white standards, wavelength standards and black references can also be used for this purpose.

DE 10 2004 021 448 B4 discloses a spectrometric reflection measuring head with internal recalibration, which consists of a housing provided with a window, an illumination source and an optical assembly for collecting the measurement light and coupling the latter into a light guide being arranged in said housing. The housing has connections to a spectrometer. In addition, at least two standards for internal recalibration are present in the housing, and can be selectively pivoted into the beam path of the reflection measuring head for the recalibration.

DE 10 2004 048 103 B4 has disclosed an arrangement for determining the constituent parts of harvested agricultural products. This arrangement comprises a spectrometric measuring head which consists of a housing provided with a window, an illumination source, a spectrometer arrangement and at least two standards for internal recalibration being present in said housing. The standards can be pivoted into the beam path of the measuring head in such a way that the entire measurement light emanating from the illumination source is used for recalibration purposes.

DE 10 2018 103 509 B3 has disclosed a method for sample-appropriate measurement using a mobile constituent analysis system which comprises a housing with a window, an interface for an external reference unit, a display and operating unit, a light source, an optical spectrometer, a camera, an internal reference unit and an electronic control unit.

DE 10 2017 108 552 B4 relates to a spectrometric measuring head with a measuring surface that is positionable relative to an examination surface of a sample. The measuring head comprises a light source and at least one illumination window in the measuring surface, through which light provided by the light source is emitted in the direction of the examination surface of the sample. At least two transmission light entrance windows are likewise positioned in the measuring surface and allow light reflected by the sample to enter. Each transmission light entrance window is spaced apart from the illumination window by a predetermined, mutually different amount.

DE 10 2007 007 040 A1 teaches a measuring device for the optical and spectroscopic examination of a sample. The measuring device comprises a housing, a first light source, a window, an optical spectrometer with a dispersive element and a number of detector elements. An incidence opening of an electronic camera is directed at the sample through the window. It is proposed that a second light source is assigned to the camera.

US 2014/0362382 A1 discloses an apparatus for detecting matter. The apparatus comprises a first light source for emitting a first light beam and a second light source for emitting a second light beam. The first light beam and the second light beam are directed at a scanning element in the form of a rotatable polygon mirror. The scanning element redirects the first light beam and second light beam to the matter to be detected. A detector receives light reflected by the matter via the scanning element. The detector can be a spectrometer.

DE 10 2009 050 371 B3 discloses a method for the spectrometric measurement of a material stream moving in a longitudinal direction. According to this method, an illumination region on the material stream is illuminated with an illumination beam generated in a radiation source.

Radiation reflected at a measurement region on the material stream is at least partially collected by means of optical components and forwarded to a spectrometer. The illumination region covers the measurement region. The illumination region and the measurement region are stationary in the longitudinal direction. A spectrometric analysis of the radiation guided to the spectrometer is performed.

EP 1 740 928 B1 discloses a method for the internal recalibration of a spectrometric measuring head. An illumination source, a spectrometer arrangement and at least two internal standards for recalibration are arranged in a housing provided with a window. Measured values are acquired and processed by a processor and transmitted to a bus system via an interface. The internal standards are selectively pivoted into the beam path of the measuring head such that the measurement light emanating from the illumination source is used for recalibration and measurement data of the internal standards are acquired by the spectrometer arrangement, so that a recalibration can be performed using the measurement data of the internal standards and stored measured values for at least two additional external standards.

DE 10 2017 217 280 A1 discloses a measuring device for particle measurement with a measuring chamber and with a transmitting device for generating an optical signal for feeding into the measuring chamber. A receiving device is used for receiving the optical signal from the measuring chamber via a first optical path for determining an influencing of the optical signal by particles in the measuring chamber.

### SUMMARY OF THE INVENTION

The object of the present invention, proceeding from the prior art, is to provide a spectrometer which is configured for example for the analysis of constituents of agricultural products on a harvester, and which has a small structural height in order to be able to be arranged on the harvester in a space-saving manner. For example, on a harvester, it is often necessary to arrange the spectrometer at the highest position of the harvester above a discharge from the harvester, where the structural height of the spectrometer directly determines the structural height of the harvester. A maximum structural height must be complied with for the harvester to be allowed on the road, and so there is a requirement to be able to implement the spectrometer with a very small structural height.

The stated object is achieved by means of a spectrometer as claimed in the attached claim 1.

The spectrometer according to the invention is used to measure a spectrum of electromagnetic radiation in order to spectrally analyze a sample. The electromagnetic radiation is preferably ultraviolet radiation, visible light and/or infrared radiation. The spectrometer is in particular an optical measuring system for ascertaining constituents of a sample on a spectroscopic basis. It preferably serves to ascertain constituents of agricultural products, harvested crops or foodstuffs. In this respect, the respective agricultural product or harvested crop or foodstuff forms the sample for spectral analysis. The spectrometer is preferably arranged on an agricultural machine such as for example on a forage harvester or on some other agriculturally used machine and is configured for continuous inspection of an agricultural product or the harvested crop. The spectrometer is preferably configured for a reflection measurement. The spectrometer is preferably configured as a polychromator.

For continuous inspection of the agricultural product, either the harvested crop is moved past the spectrometer or the spectrometer is moved past the harvested crop. With the aid of the measurement results, various constituents such as for example moisture, protein, starch, oil content and/or else properties such as for example cut length, fiber condition or temperature of the measured material can be determined on the basis of calibrations.

The spectrometer comprises a radiation source for irradiating the sample with electromagnetic radiation. The electromagnetic radiation is preferably ultraviolet radiation, visible light and/or infrared radiation. In this respect, the radiation source is preferably formed by a light source. The electromagnetic radiation generated by the radiation source is incident on the sample and is at least partially reflected by the sample. The reflected electromagnetic radiation is spectrally analyzed by the spectrometer in order to draw conclusions about the sample and the constituents thereof and also further properties.

The spectrometer comprises a dispersive element for the spatiospectral splitting of the electromagnetic radiation reflected by the sample. The electromagnetic radiation is diffracted or refracted by the dispersive element to different extents depending on the wavelength, such that a spectrum of the reflected electromagnetic radiation is manifested.

The spectrometer comprises a measurement window for transmitting the electromagnetic radiation generated by the radiation source from the radiation source to the sample and for transmitting the electromagnetic radiation reflected by the sample from the sample to the dispersive element. A window axis of the measurement window is oriented perpendicular to the measurement window.

The electromagnetic radiation generated by the radiation source passes on a first inner beam path from the radiation source to the measurement window. The first inner beam path thus constitutes part of an illumination beam path. The electromagnetic radiation reflected by the sample passes on a second inner beam path from the measurement window to the dispersive element. The second inner beam path thus constitutes part of a measurement beam path.

The spectrometer additionally comprises a spatially resolving detector for the wavelength-dependent conversion of the spatiospectrally split electromagnetic radiation. Locations on the spatially resolving detector are respectively assigned to a wavelength of the spatiospectrally split electromagnetic radiation. The spatial resolution of the detector thus enables a wavelength-dependent measurement to be carried out.

The spectrometer furthermore comprises a deflection mirror arranged on the first inner beam path and on the second inner beam path and serving for jointly deflecting the first inner beam path and the second inner beam path. Consequently, the first inner beam path passes the deflection mirror on its way from the radiation source to the measurement window, the first inner beam path being deflected at said mirror. The second inner beam path passes the deflection mirror on its way from the measurement window to the dispersive element, the second inner beam path also being deflected at said mirror. The deflection of the two inner beam paths makes it possible that the radiation source and the dispersive element can be arranged horizontally next to the window axis rather than in the usually vertically oriented window axis, such that the structural height of the spectrometer can be made smaller without this necessitating miniaturization of the components of the spectrometer, which is usually not possible owing to robustness requirements with regard to vibrations, shocks and temperature range.

One particular advantage of the spectrometer according to the invention is that it can be embodied as a compact reflection measuring head for a harvester, for example. In this regard, the spectrometer can be arranged above a discharge chute of the harvester for chopped material, without any relevant increase in the total structural height of the harvester, which is restricted to 4.00 m for the harvester to be allowed on the road, for example, or without any loss of height for functionally important assemblies of the harvester, such as balloon tires, for example.

A further advantage of the spectrometer according to the invention is that the requirements hitherto imposed on spectrometers for analyzing constituents of agricultural products on harvesters can still be satisfied despite the reduced structural height of, for example, 60 mm to 80 mm. In this regard, a measurement spot of the spectrometer can have a diameter of at least 20 mm, which—for example for examining corn—is necessary on account of the size of the corn kernels and the inhomogeneity of the sample. The integration time that occurs during the measurement using the spectrometer can be restricted to at most 15 ms, which corresponds for example to a measurement at five constituent values per second and a material speed of up to 100 km/h. An optical measurement geometry used hitherto in the prior art can be maintained in order that calibration models already created can continue to be used. In this respect, the spectrometer can be made downward-compatible, such that the hitherto customary distance and angle with respect to the sample remain unchanged and accessories for such spectrometers, such as a flange, a turntable and sample trays, for example, are still usable. Preferably, therefore, an angle between the illumination beam path and a normal to a plane of the sample or the window axis of the measurement window is chosen in the same way that it was chosen for the creation of calibration models with spectrometers in accordance with the prior art.

In preferred embodiments, the deflection mirror is configured to deflect the first inner beam path and the second inner beam path by a deflection angle which is between 60° and 120°. The deflection angle is further preferably between 80° and 100°. The deflection angle is particularly preferably 90° taking into account manufacturing tolerances. This enables a particularly compact embodiment of the spectrometer.

A first portion of the first inner beam path is formed between the radiation source and the deflection mirror. A first portion of the second inner beam path is formed between the deflection mirror and the dispersive element. The first portion of the first inner beam path and the first portion of the second inner beam path are preferably arranged jointly in a first plane. The designation given here for the first portions is only for differentiation purposes and does not relate to the temporal formation of the respective beam path.

A second portion of the first inner beam path is formed between the deflection mirror and the measurement window. A second portion of the second inner beam path is formed between the measurement window and the deflection mirror. The second portion of the first inner beam path and the second portion of the second inner beam path preferably lie jointly in a second plane. The window axis preferably likewise lies in the second plane. The second plane is preferably arranged perpendicular to the first plane. The designation given here for the second portions is only for differentiation purposes and does not relate to the temporal formation of the respective beam path.

In preferred embodiments, the first plane is arranged horizontally. The second plane is preferably arranged vertically. In this case, the deflection angle is 90°.

The measurement window preferably lies in a horizontal plane. The measurement window is preferably arranged above or below the deflection mirror, this depending on the use position of the spectrometer. The measurement window is particularly preferably arranged below the deflection mirror, this resulting from a use position of the spectrometer in which the spectrometer is oriented for an examination of a sample situated below the spectrometer.

A third inner beam path is preferably formed from the dispersive element to the spatially resolving detector. The third inner beam path thus forms part of the measurement beam path. The third inner beam path is preferably likewise arranged in the first plane, such that at least portions of the three inner beam paths lie jointly in the first plane.

In a first preferred embodiment, the deflection mirror is arranged fixedly within the spectrometer. In this case, the spectrometer preferably furthermore comprises a movable reference carrier with at least one optical reference which is pivotable into the first inner beam path and into the second inner beam path between the deflection mirror and the measurement window. The optical reference is pivotable in particular into the second portion of the first inner beam path and into the second portion of the second inner beam path. The optical reference is preferably formed by a white standard, by a grayscale standard or by a black standard. The reference carrier preferably comprises at least two of the optical references which preferably comprise a white standard and a black standard.

The reference carrier is preferably formed by a rotatable rotary disk. In this case, the reference carrier is rotatable about a rotation axis which is preferably arranged parallel to the second plane. The rotation axis is preferably arranged parallel to the window axis. The rotatable rotary disk is preferably subdivided into a plurality of circle sectors, wherein one of the circle sectors is transmissive to radiation in order to enable the measurements of the sample using the spectrometer. One or more of the circle sectors each have one of the at least one optical reference. In order to calibrate the spectrometer, one of the optical references is to be pivoted into the first inner beam path and into the second inner beam path between the deflection mirror and the measurement window by the rotatable rotary disk being rotated. This causes the respective optical reference to become effective, such that a reference measurement can be carried out using the optical reference with the spectrometer.

In a second preferred embodiment, the deflection mirror is tiltable between a first tilt position and a second tilt position and back. In this case, the first tilt position constitutes the position which is required for the measurement of the sample and in which, as described above, the deflection mirror is oriented for forming and jointly deflecting the first inner beam path and the second inner beam path. In the second tilt position, the deflection mirror is oriented for a reflection of the electromagnetic radiation generated by the radiation source onto the dispersive element. Consequently, the electromagnetic radiation does not reach the measurement window and hence does not reach the sample either, rather it is directed directly to the dispersive element, such that an internal reference measurement, namely an internal white measurement, is made possible, enabling the spectrometer to be calibrated. In the second tilt position, the deflection mirror can be arranged in a manner inclined by an angular difference of, for example, 10° from a direct connecting line with respect to the dispersive element. In this case, the deflection mirror can be configured for an angle-dependent reflection, such that the entire incident radiation from the radiation source is not reflected to the dispersive element, rather in part the radiation is transmitted through the deflection mirror and or in part it is absorbed by the deflection mirror. Alternatively or supplementarily, the deflection mirror can have an electrochromic layer. The electrochromic layer preferably consists of a material which changes the passage of light depending on an applied DC voltage. Consequently, the transmission and thus also the reflection of the deflection mirror are electrically controllable, such that the reflection can be reduced in particular in the second tilt position, as a result of which the entire incident radiation from the radiation source is not reflected to the dispersive element.

The deflection mirror is tiltable between the first tilt position and the second tilt position preferably about a tilt axis. The tilt axis thus constitutes a rotation axis. The tilt axis preferably lies in the first plane, and so the tilt axis is preferably arranged horizontally. The tilt axis preferably lies in the deflection mirror. The tilt axis preferably lies in a central axis of the deflection mirror.

The spectrometer preferably comprises a tilt actuator for tilting the deflection mirror between the first tilt position and the second tilt position, and vice versa.

In a third preferred embodiment, the deflection mirror is pivotable between a first pivot position and a second pivot position, and vice versa. In this case, the first pivot position constitutes the position which is required for the measurement of the sample and in which, as described above, the deflection mirror is oriented for forming and jointly deflecting the first inner beam path and the second inner beam path. In the first pivot position, the deflection mirror is moreover arranged between, on one side, a reference carrier—carrying at least one optical reference—of the spectrometer and, on the other side, the radiation source and the dispersive element. Consequently, no relevant radiation from the radiation source passes from the radiation source to the reference carrier because the deflection mirror is situated in between. Just as little radiation passes from the reference carrier to the dispersive element since the deflection mirror is situated in between. The reference carrier carries at least one optical reference. The reference carrier can be arranged fixedly within the spectrometer; particularly if the reference carrier comprises the exactly one optical reference; for example if the optical reference also has an electrochromic layer, which enables different reference measurements. The reference carrier can also comprise a plurality of the optical references and be embodied as displaceable and/or rotatable in order to direct in each case one of the optical references to the radiation source.

The optical references preferably comprise a white standard, a grayscale standard and/or a black standard. In the second pivot position, the deflection mirror releases a beam path from the radiation source to the reference carrier and also a beam path from the reference carrier to the dispersive element. As a result, the radiation from the radiation source passes from the radiation source to the reference carrier, where it is reflected and/or absorbed by the optical reference and/or is transmitted through the optical reference, wherein the reflected portion of the radiation passes to the dispersive element. Consequently, the electromagnetic radiation does not reach the measurement window and hence does not reach the sample either, rather that portion of the electromagnetic radiation which is reflected by the optical reference is directed directly to the dispersive element, such that an internal reference measurement on the basis of the optical reference is made possible, enabling the spectrometer to be calibrated. In the second pivot position, the deflection mirror is arranged in a manner pivoted out of an imaginary connecting line between the reference carrier with the at least one optical reference and the radiation source and also out of an imaginary connecting line between the reference carrier with the at least one optical reference and the dispersive element.

The deflection mirror is pivotable between the first pivot position and the second pivot position preferably about a pivot axis. The pivot axis thus constitutes a rotation axis. The pivot axis preferably lies parallel to the first plane, and so the pivot axis is preferably arranged horizontally. The pivot axis preferably has an offset with respect to the first plane. The pivot axis is preferably arranged spaced apart from a plane encompassing the deflection mirror.

The spectrometer preferably comprises a pivot actuator for pivoting the deflection mirror between the first pivot position and the second pivot position, and vice versa.

The third preferred embodiment preferably additionally comprises the movable reference carrier between the deflection mirror and the measurement window, said movable reference carrier having been described in association with the first preferred embodiment and preferably being formed by a rotatable rotary disk.

In a fourth preferred embodiment, the deflection mirror is arranged fixedly within the spectrometer and has an electrochromic layer, such that the reflection of the deflection mirror is electrically controllable and can be reduced in particular for a reference measurement.

The spectrometer is preferably configured such that a first optical path length from the radiation source via the deflection mirror to the sample and back from the sample via the deflection mirror to the dispersive element and a second optical path length from the radiation source to the optical reference and back from the optical reference to the dispersive element are equal in length. It is specifically advantageous that the pivotable deflection mirror enables these two optical path lengths to be kept equal in length, such that the calibrations can be performed particularly accurately using the at least one reference.

In preferred embodiments, the deflection mirror is inclined by 45° relative to the first plane. Insofar as the deflection mirror is tiltable or pivotable, this inclination of preferably 45° applies to the first tilt position or respectively to the first pivot position.

In preferred embodiments, the first portion of the first inner beam path and the first portion of the second inner beam path are at an angle to one another which is between 10° and 60°. This angle is further preferably between 20° and 50°.

The first portion of the first inner beam path has an angle of incidence with which it is incident on the deflection mirror. The first portion of the second inner beam path has an angle of reflection with which it leaves the deflection mirror. The angle of incidence and the angle of reflection are preferably equal in magnitude.

In preferred embodiments, the spectrometer comprises a housing, in which the radiation source, the dispersive element, the spatially resolving detector and the deflection mirror are arranged. The measurement window forms part of an upper side or of a lower side of the housing. The measurement window preferably forms part of the lower side of the housing. The housing has a height which is preferably at most 80 mm, further preferably at most 60 mm and even further preferably at most 40 mm. It is specifically a particular advantage of the spectrometer that it can be embodied as a compact reflection measuring head having a small structural height, for example for a harvester. In this regard, the spectrometer can be arranged above a discharge chute of the harvester for chopped material, without any relevant increase in the total structural height of the harvester, which is restricted to 4.00 m for the harvester to be allowed on the road, for example, or without any loss of height for functionally important assemblies of the harvester, such as balloon tires, for example.

The spectrometer additionally preferably comprises at least one external optical reference arranged outside the housing.

The dispersive element is preferably formed by a diffraction grating. The electromagnetic radiation that is reflected by the sample and is to be analyzed is thus diffracted at the diffraction grating. The electromagnetic radiation that is diffracted by the diffraction grating and is to be analyzed is directed onto the spatially resolving detector. The dispersive element can alternatively be formed by some other light-diffracting element. The dispersive element can alternatively be formed by a light-refracting element, such as a prism.

The spatially resolving detector is preferably formed by a detector linear array. The detector linear array comprises at least detector elements arranged linearly in a linear array, which detector elements may also be referred to as pixels.

The spectrometer preferably furthermore comprises a control and measurement signal processing unit in the form of a computing unit. The control and measurement signal processing unit serves for controlling the radiation source and for processing an output signal of the spatially resolving detector and optionally for controlling the tilt or pivot actuator and/or the electrochromic layer. The control and measurement signal processing unit preferably comprises a graphical user interface for the operator control of the spectrometer. The control and measurement signal processing unit preferably has data interfaces, which can also be embodied in a wireless fashion. The control and measurement signal processing unit is preferably configured to the effect that the spectrometer independently calibrates itself.

In preferred embodiments, the spectrometer furthermore comprises a beam splitter and an electronic image converter. The beam splitter is arranged on the second inner beam path and splits a camera partial beam path out of the second inner beam path. The camera partial beam path is directed indirectly or directly at the image converter. Consequently, the second inner beam path does not just serve to spectrally analyze the sample with the aid of the dispersive element and the spatially resolving detector, but also serves to image the sample with the image converter. In this respect, the spectrometer comprises an integrated camera on the basis of the electronic image converter. An image of the sample that has been imaged by the image converter can be displayed, such that an operator of the spectrometer can visually perceive the sample in order to be able to detect contaminations of the sample, for example. Alternatively or supplementarily, the image of the sample can be processed by machine, the control and measurement signal processing unit preferably being configured for this. One particular advantage of the camera integrated in the spectrometer on the basis of the electronic image converter is that splitting of the second inner beam path enables the image converter to be integrated in the spectrometer in a space-saving manner, without this necessitating an increase in the structural height of the spectrometer. For this purpose, the camera partial beam path preferably lies in the first plane, in which also lie the first portion of the first inner beam path between the radiation source and the deflection mirror and the first portion of the second inner beam path between the deflection mirror and the dispersive element. A further particular advantage is that the integrated camera is directed at that region of the sample which is spectrally examined by the spectrometer, since the image for the image converter is likewise coupled out from the second inner beam path. This makes it possible to ensure that those disturbing influences, such as reflections, for example, which actually adversely affect the spectral examination can be visually identified in the image of the camera. The beam splitter and the image converter are preferably likewise arranged in the housing of the spectrometer.

The beam splitter is preferably formed by a partially transmissive mirror. The partially transmissive mirror is preferably arranged in a manner inclined by 45° with respect to the second inner beam path, such that the camera partial beam path is at an angle of 90° with respect to the second inner beam path. The beam splitter can alternatively also be formed by a beam splitter prism or the like. The beam splitter is preferably configured for spectrally splitting the second inner beam path, wherein the camera partial beam path preferably comprises only the visual part of the electromagnetic spectrum.

In preferred embodiments, the beam splitter is arranged on the second inner beam path between the deflection mirror and the dispersive element, and so it is situated in the first portion of the second inner beam path.

The electronic image converter is preferably formed by a CMOS image converter or by a CCD image converter. The electronic image converter may also be referred to as an image sensor or a camera chip. The electronic image converter is preferably configured for converting color images. The electronic image converter is preferably configured for converting moving images.

In preferred embodiments, the spectrometer comprises a camera lens arranged on the camera partial beam path between the beam splitter and the image converter. The camera lens images the sample on the image converter. The camera lens is preferably likewise situated in the housing. The camera lens and the image converter form the integrated camera.

In preferred embodiments, the image converter forming an image plane, the camera lens forming a lens plane, the beam splitter, the deflection mirror and an object plane of the sample arranged parallel to the measurement window are arranged with respect to one another such that the Scheimpflug condition is complied with. According to the Scheimpflug condition, focal plane, lens plane and image plane intersect in a common straight line. The focal plane ought to lie in the object plane formed by the sample. The sample is situated outside the spectrometer in front of the measurement window during the measurement, wherein the object plane formed by the sample is arranged parallel to the measurement window. A measurement distance is formed between the object plane and the measurement window. The Scheimpflug condition should be complied with since, on account of the inclined viewing direction of the second inner beam path, the object plane is not perpendicular to the axis of the second inner beam path, which necessitates an image plane that is likewise inclined with respect to the axis in order to completely sharply image the object plane. Complying with the Scheimpflug condition has the effect, however, that the image is fully sharply imaged. The Scheimpflug condition should be applied in the present case taking into account the deflection at the deflection mirror and the deflection at the beam splitter. Complying with the Scheimpflug condition results in the image converter being inclined relative to the camera partial beam path.

### BRIEF DESCRIPTION OF THE DRAWINGS

Further details and developments of the invention will become apparent from the following description of preferred embodiments of the invention, with reference being made to the drawing, in which:

FIG. 1 shows a schematic illustration of a first preferred embodiment of a spectrometer according to the invention during a sample measurement;

FIG. 2 shows the first preferred embodiment of the spectrometer shown in FIG. 1 during the sample measurement in a further view;

FIG. 3 shows the first preferred embodiment of the spectrometer shown in FIG. 1 during a reference measurement;

FIG. 4 shows the first preferred embodiment of the spectrometer shown in FIG. 3 during the reference measurement in a further view;

FIG. 5 shows a schematic illustration of a second preferred embodiment of the spectrometer according to the invention during a reference measurement;

FIG. 6 shows the second preferred embodiment of the spectrometer shown in FIG. 5 during the reference measurement in a further view;

FIG. 7 shows a schematic illustration of a third preferred embodiment of the spectrometer according to the invention during a sample measurement;

FIG. 8 shows the third preferred embodiment of the spectrometer shown in FIG. 7 during the sample measurement in a further view;

FIG. 9 shows the third preferred embodiment of the spectrometer shown in FIG. 7 during a reference measurement;

FIG. 10 shows the third preferred embodiment shown in FIG. 9 during the reference measurement in a further view;

FIG. 11 shows a schematic illustration of a fourth preferred embodiment of the spectrometer according to the invention during a sample measurement;

FIG. 12 shows the fourth preferred embodiment of the spectrometer shown in FIG. 11 during a reference measurement;

FIG. 13 shows a schematic illustration of a fifth preferred embodiment of the spectrometer according to the invention during a sample measurement;

FIG. 14 shows the fifth preferred embodiment of the spectrometer shown in FIG. 13 during a reference measurement;

FIG. 15 shows a schematic illustration of a sixth preferred embodiment of the spectrometer according to the invention; and

FIG. 16 shows the sixth preferred embodiment shown in FIG. 15 in a further view.

### DETAILED DESCRIPTION OF THE INVENTION

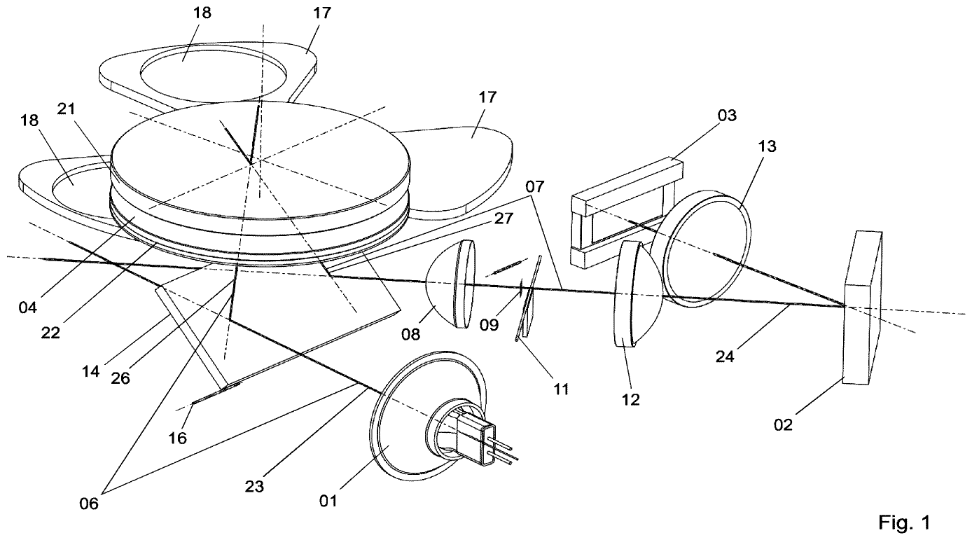

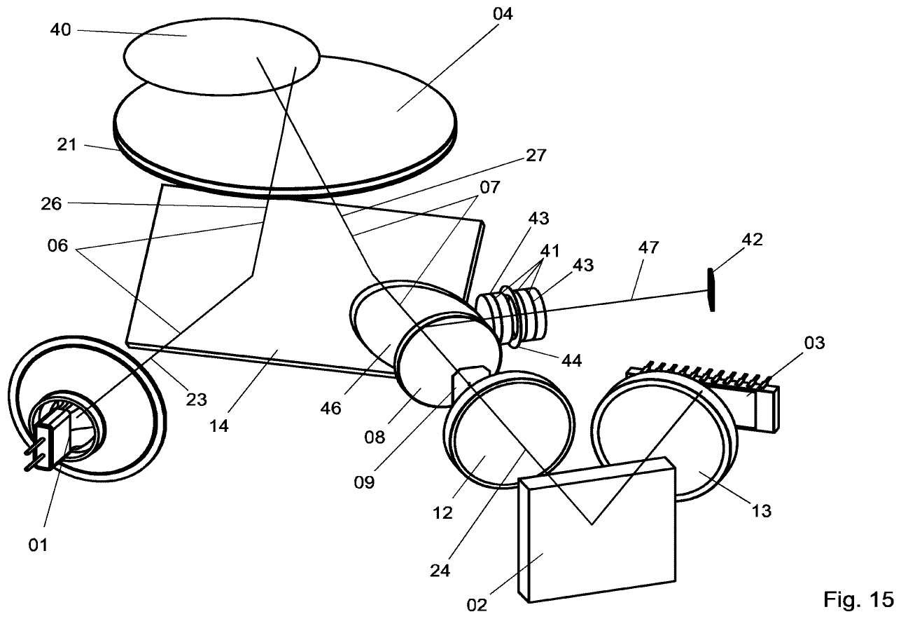

FIG. 1 shows a schematic illustration of a first preferred embodiment of a spectrometer according to the invention during a spectral measurement of a sample 40 (shown in FIG. 15). Arranged in a housing (not shown) of the spectrometer are a light source 01, a diffraction grating 02 and a detector linear array 03, which serve for spectrally analyzing the sample 40 (shown in FIG. 15). The housing (not shown) has a measurement window 04, which is to be directed at the sample 40 (shown in FIG. 15).

The light (not illustrated) generated by the light source 01 passes on a first inner beam path 06 from the light source 01 to the measurement window 04, from which said light emerges and is incident on the sample 40 (shown in FIG. 15). The sample 40 (shown in FIG. 15) reflects this light (not illustrated) according to its reflective properties. The reflected light (not illustrated) passes through the measurement window 04 into the spectrometer and passes on a second inner beam path 07 from the measurement window 04 to the diffraction grating 02. On this second inner beam path 07, the light passes through a first lens element 08, through a slit 09, through a shutter 11 and through a second lens element 12. After passing the diffraction grating 02, the light passes through a third lens element 13 before it is incident on the detector linear array 03.

The spectrometer furthermore comprises a deflection mirror 14, which serves for jointly deflecting the first inner beam path 06 and the second inner beam path 07. In the preferred embodiment shown, a deflection by 90° is effected. The deflection mirror 14 is fixed in the first preferred embodiment shown, such that a tilt axis 16 is not used here.

The spectrometer furthermore comprises a reference carrier 17 in the form of a rotatable rotary disk. The reference carrier 17 carries optical references 18. For the measurement of the sample 40 (shown in FIG. 15), the reference carrier 17 is rotated in such a way that none of the references 18 is situated in the first inner beam path 06 and in the second inner beam path 07.

Arranged above the measurement window 04 is a sapphire glass 21 for protecting the measurement window 04. Situated below the measurement window 04 is a stop 22.

A first portion 23 of the first inner beam path 06 between the light source 01 and the deflection mirror 14 and also a first portion 24 of the second inner beam path 07 between the deflection mirror 14 and the diffraction grating 02 lie jointly in a first plane (not illustrated), which is oriented horizontally. A second portion 26 of the first inner beam path 06 between the deflection mirror 14 and the measurement window 04 and also a second portion 27 of the second inner beam path 07 between the measurement window 04 and the deflection mirror 14 lie jointly in a second plane (not illustrated) arranged perpendicular to the first plane (not illustrated), such that it is oriented vertically.

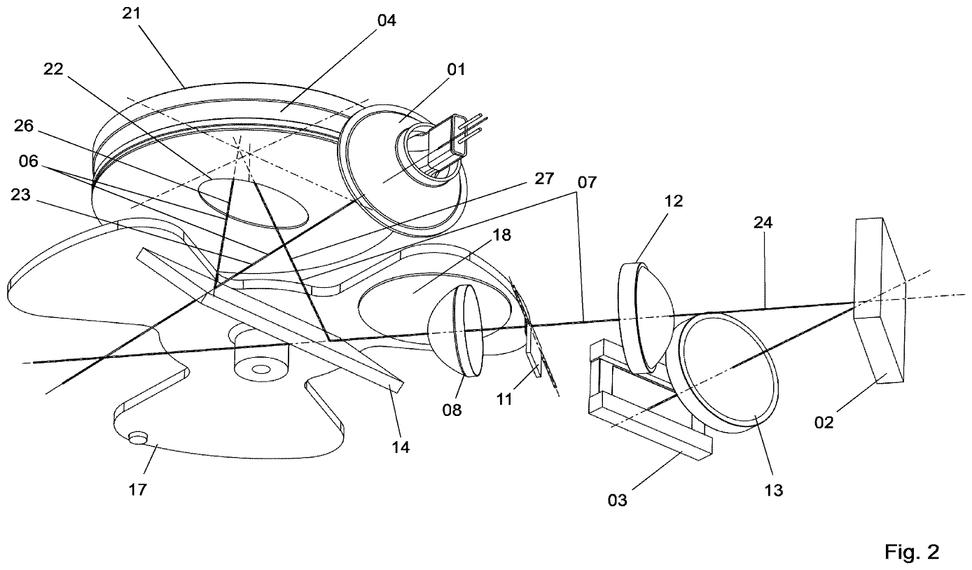

FIG. 2 shows the first preferred embodiment of the spectrometer shown in FIG. 1 in a further view. This further view reveals in particular the second portion 26 of the first inner beam path 06 and the second portion 27 of the second inner beam path 07.

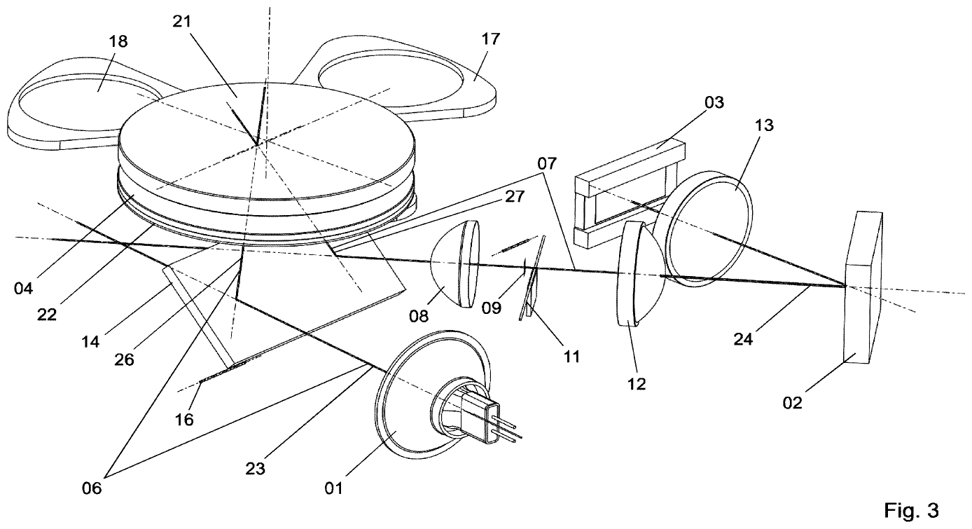

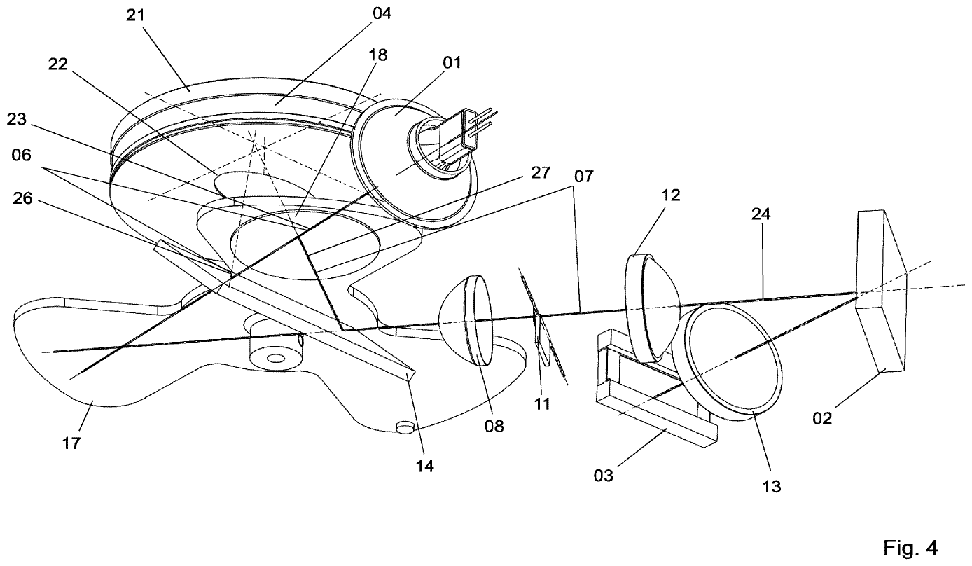

FIG. 3 shows the first preferred embodiment of the spectrometer shown in FIG. 1 during a reference measurement. For the reference measurement, the reference carrier 17 was rotated in such a way that one of the references 18 (shown in FIG. 4) is situated in the first inner beam path 06 and in the second inner beam path 07.

FIG. 4 shows the first preferred embodiment of the spectrometer shown in FIG. 3 during the reference measurement in a further view. This further view reveals in particular the reference 18.

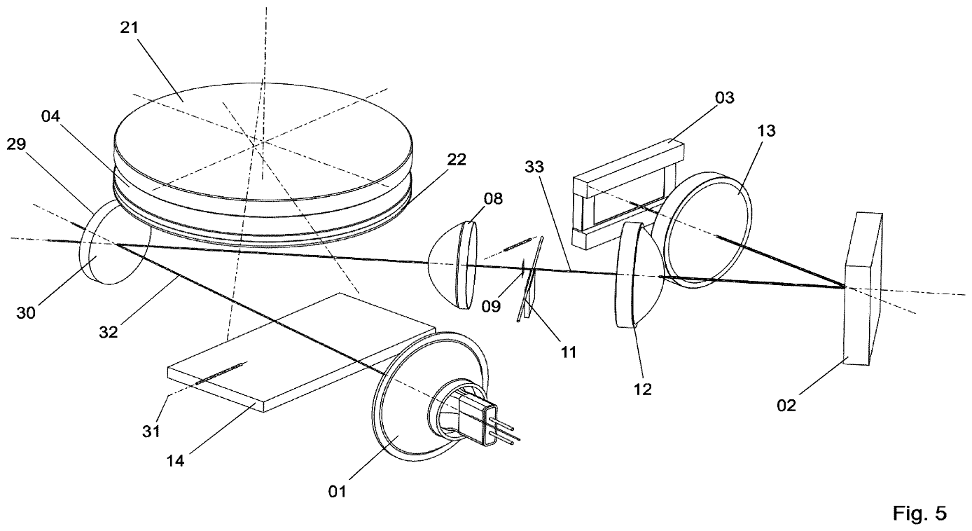

FIG. 5 shows a schematic illustration of a second preferred embodiment of the spectrometer according to the invention during a reference measurement. This second preferred embodiment initially resembles the first preferred embodiment shown in FIG. 1. In contrast to the first preferred embodiment shown in FIG. 1, the second preferred embodiment has a fixedly arranged reference carrier 29 with a reference 30, instead of the rotatable reference carrier 17. In contrast to the first preferred embodiment shown in FIG. 1, in the case of the second embodiment, the deflection mirror 14 is pivotable or tiltable about a pivot axis 31 between a first pivot position and a second pivot position. In the second pivot position shown here, the deflection mirror 14 releases a beam path 32 from the light source 01 to the reference 30 situated on the fixedly arranged reference carrier 29, and a beam path 33 from the reference 30 situated on the fixedly arranged reference carrier 29 to the diffraction grating 02.

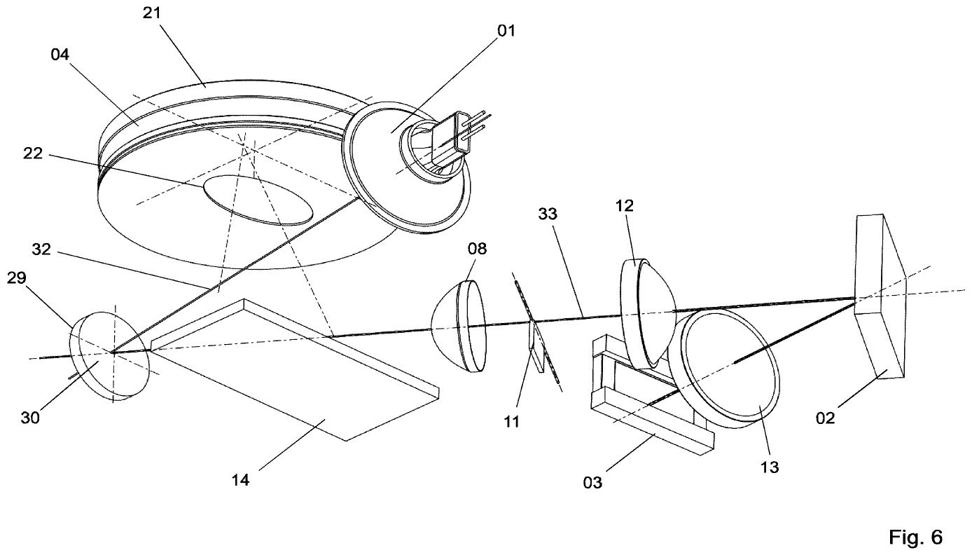

FIG. 6 shows the second preferred embodiment of the spectrometer shown in FIG. 5 during the reference measurement in a further view. This further view reveals in particular the position of the deflection mirror 14 during the reference measurement.

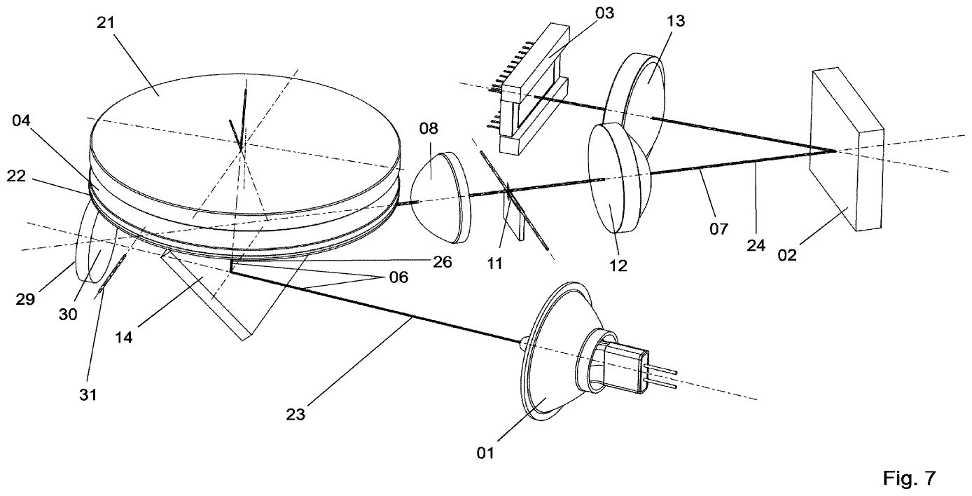

FIG. 7 shows a schematic illustration of a third preferred embodiment of the spectrometer according to the invention during the measurement of a sample 40 (shown in FIG. 15). This third preferred embodiment initially resembles the second preferred embodiment shown in FIG. 5. In contrast to the second preferred embodiment shown in FIG. 5, in the case of the third preferred embodiment, the pivot axis 31 of the deflection mirror 14 is arranged outside a plane encompassing the deflection mirror 14. In the illustration shown, the deflection mirror 14 is situated in its first pivot position, in which it is oriented for forming the first inner beam path 06 and the second inner beam path 07. In its first pivot position the deflection mirror 14 is arranged between, on one side, the reference 30 situated on the reference carrier 29 and, on the other side, the light source 01 and the diffraction grating 02.

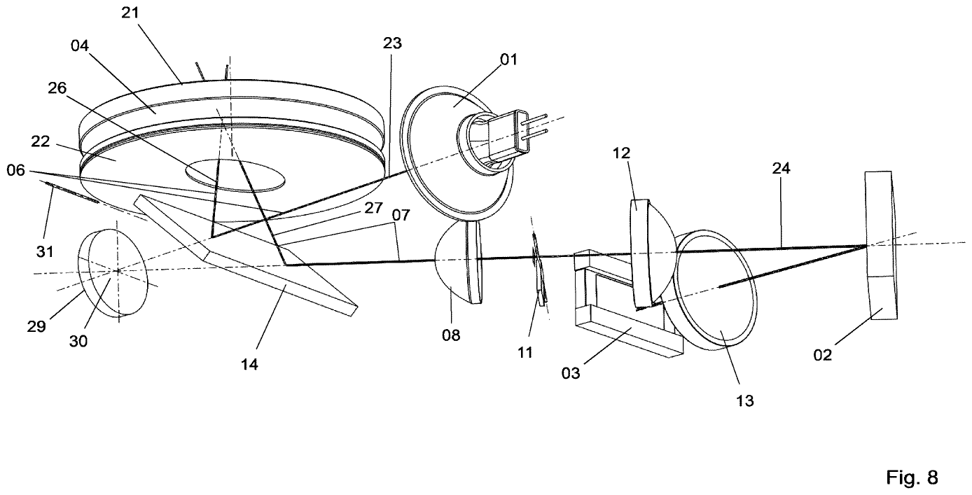

FIG. 8 shows the third preferred embodiment shown in FIG. 7 during the measurement of the sample 40 (shown in FIG. 15) in a further view. This further view reveals in particular the position of the deflection mirror 14 during the measurement of the sample 40 (shown in FIG. 15).

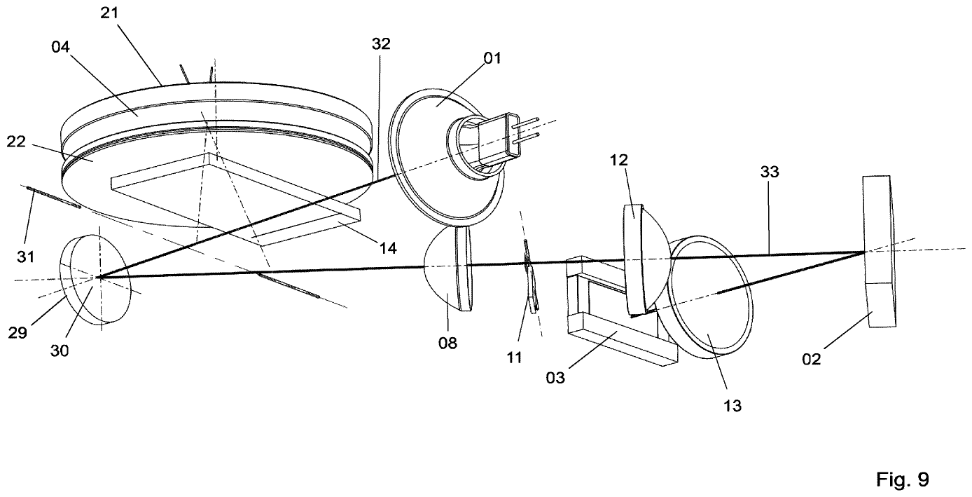

FIG. 9 shows the third preferred embodiment shown in FIG. 7 during a reference measurement. For this purpose, the deflection mirror 14 is situated in its second pivot position, in which it releases the beam path 32 from the light source 01 to the reference 30 situated on the fixedly arranged reference carrier 29, and the beam path 33 from the reference 30 situated on the fixedly arranged reference carrier 29 to the diffraction grating 02.

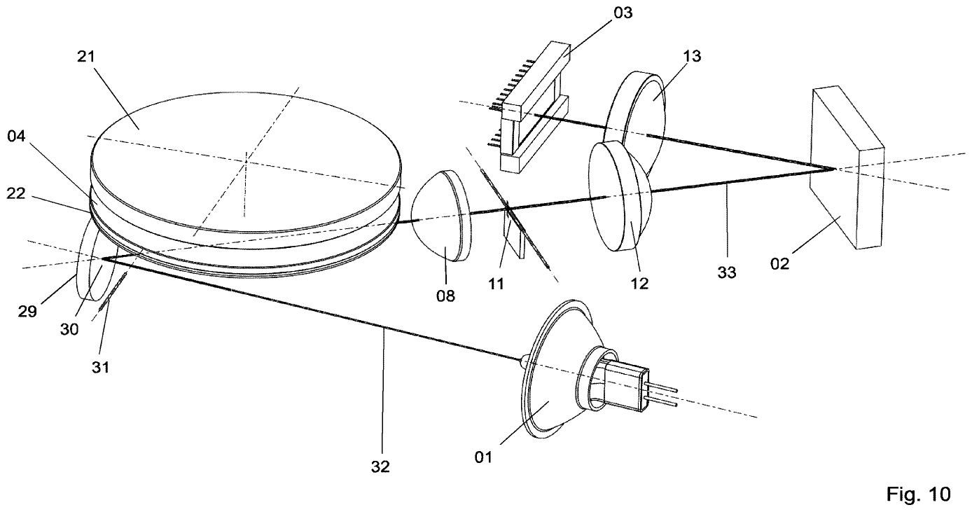

FIG. 10 shows the third preferred embodiment shown in FIG. 9 during the reference measurement in a further view. This further view reveals in particular the beam path 32 from the light source 01 to the reference 30 situated on the fixedly arranged reference carrier 29.

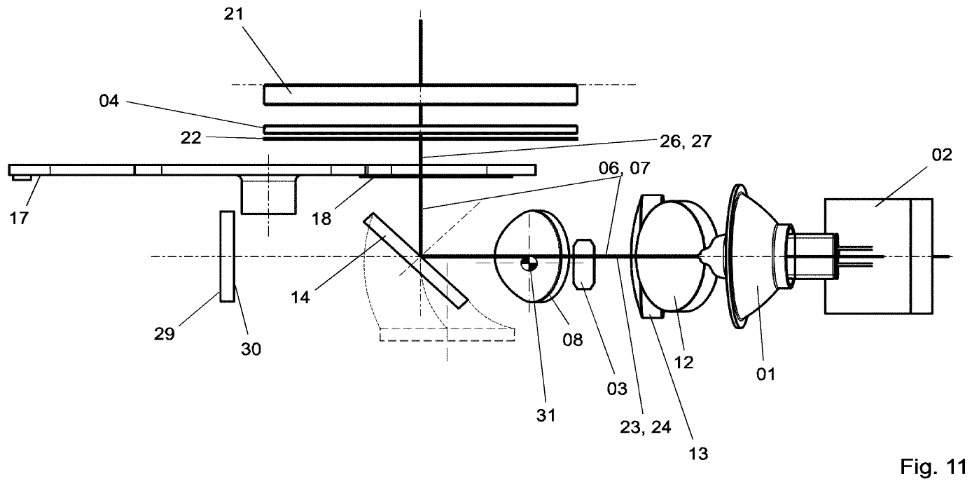

FIG. 11 shows a schematic illustration of a fourth preferred embodiment of the spectrometer according to the invention in a cross-sectional view during the measurement of a sample 40 (shown in FIG. 15). This fourth preferred embodiment initially resembles the first preferred embodiment shown in FIG. 1. In contrast to the first preferred embodiment shown in FIG. 1, this fourth preferred embodiment also has the fixedly arranged reference carrier 29 with the reference 30 as shown in FIG. 5. As in the second preferred embodiment shown in FIG. 5, the deflection mirror 14 is pivotable or swingable about the pivot axis 31 between the first pivot position and the second pivot position, but in the fourth preferred embodiment shown here the pivot axis 31 is arranged distinctly outside a plane encompassing the deflection mirror 14. In the illustration shown, the deflection mirror 14 is situated in its first pivot position, in which it is oriented for forming the first inner beam path 06 and the second inner beam path 07. In its first pivot position the deflection mirror 14 is arranged between, on one side, the reference 30 situated on the reference carrier 29 and, on the other side, the light source 01 and the diffraction grating 02. This cross-sectional view clearly reveals that the first portion 23 of the first inner beam path 06 between the light source 01 and the deflection mirror 14 and the first portion 24 of the second inner beam path 07 between the deflection mirror 14 and the diffraction grating 02 lie jointly in the first plane (not illustrated). In the same way it is discernible that the second portion 26 of the first inner beam path 06 between the deflection mirror 14 and the measurement window 04 and the second portion 27 of the second inner beam path 07 between the measurement window 04 and the deflection mirror 14 lie jointly in the second plane (not illustrated) arranged perpendicular to the first plane (not illustrated).

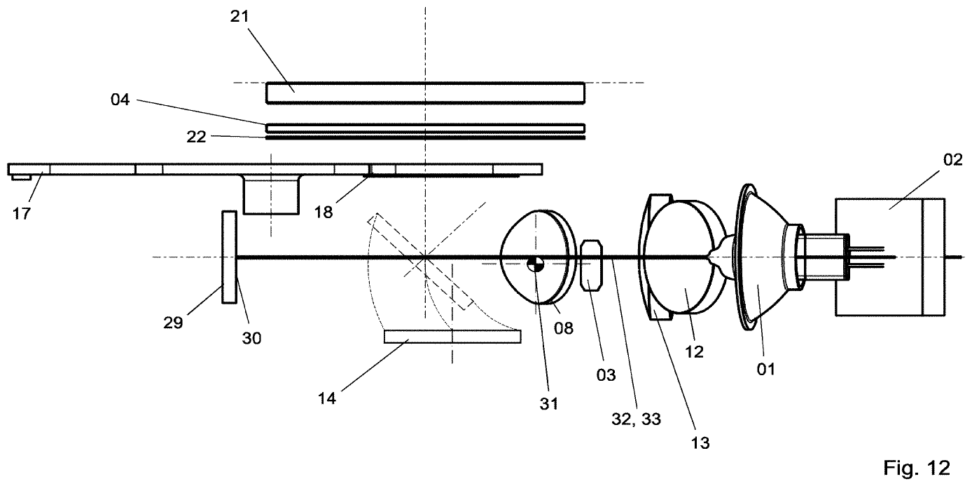

FIG. 12 shows the fourth preferred embodiment of the spectrometer shown in FIG. 11 during a reference measurement. For this purpose, the deflection mirror 14 is situated in its second pivot position, in which it releases the beam path 32 from the light source 01 to the reference 30 situated on the fixedly arranged reference carrier 29, and the beam path 33 from the reference 30 situated on the fixedly arranged reference carrier 29 to the diffraction grating 02. Since, in the fourth preferred embodiment shown here, the pivot axis 31 is arranged distinctly outside the plane encompassing the deflection mirror 14, the deflection mirror 14 in its second pivot position is situated far outside the released beam paths 32, 33.

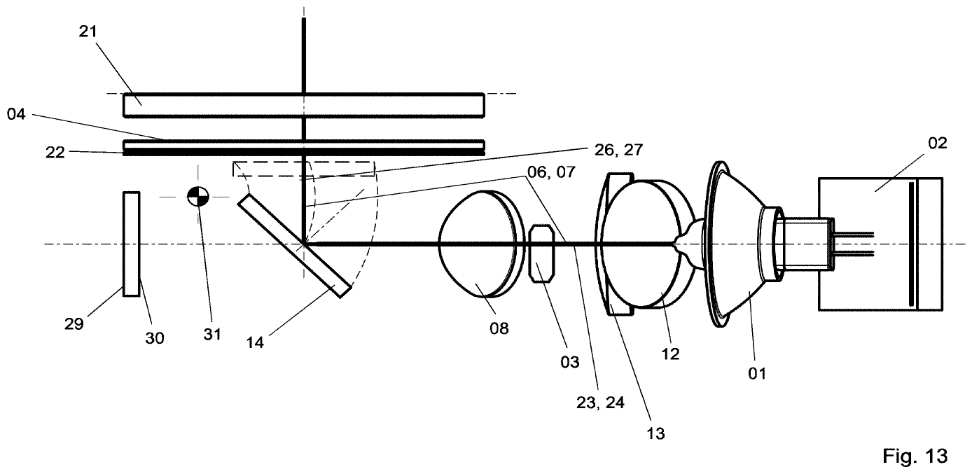

FIG. 13 shows a schematic illustration of a fifth preferred embodiment of the spectrometer according to the invention in a cross-sectional view during the measurement of a sample 40 (shown in FIG. 15). This fifth preferred embodiment initially resembles the fourth preferred embodiment shown in FIG. 11. In contrast to the fourth preferred embodiment shown in FIG. 11, this fifth preferred embodiment does not have the rotatable reference carrier 17. A further difference consists in the position of the pivot axis 31, which, in the fifth preferred embodiment shown here, is arranged distinctly outside the plane encompassing the deflection mirror 14, near the reference 30. In the illustration shown, the deflection mirror 14 is situated in its first pivot position, in which it is oriented for forming the first inner beam path 06 and the second inner beam path 07. In its first pivot position the deflection mirror 14 is arranged between, on one side, the reference 30 situated on the reference carrier 29 and, on the other side, the light source 01 and the diffraction grating 02.

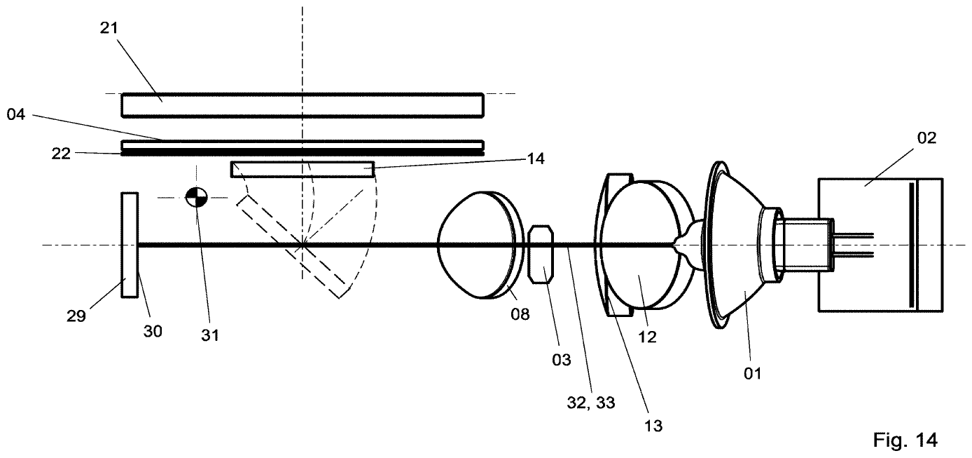

FIG. 14 shows the fifth preferred embodiment of the spectrometer shown in FIG. 13 during a reference measurement. For this purpose, the deflection mirror 14 is situated in its second pivot position, in which it releases the beam path 32 from the light source 01 to the reference 30 situated on the fixedly arranged reference carrier 29, and the beam path 33 from the reference 30 situated on the fixedly arranged reference carrier 29 to the diffraction grating 02. Since, in the fifth preferred embodiment shown here, the pivot axis 31 is arranged distinctly outside the plane encompassing the deflection mirror 14, the deflection mirror 14 in its second pivot position is situated far outside the released beam paths 32, 33.

FIG. 15 shows a schematic illustration of a sixth preferred embodiment of the spectrometer according to the invention. This sixth preferred embodiment initially resembles the first preferred embodiment shown in FIG. 1. In contrast to the first preferred embodiment shown in FIG. 1, the sixth preferred embodiment does not have a reference carrier with references. The sixth preferred embodiment shown has an integrated camera formed by a camera lens 41 and an image converter 42. The camera lens 41 comprises a plurality of lens elements 43 and a stop 44. In order that an image can be captured by the integrated camera formed by the camera lens 41 and the image converter 42, a partially transmissive mirror 46 is situated in the first portion 24 of the second inner beam path 07, and splits a camera partial beam path 47 off from the second inner beam path 07, with this being directed at the image converter 42 via the camera lens 41. The image converter 42 is inclined relative to the camera partial beam path 47 in order to comply with the Scheimpflug condition.

The sample 40 situated above the measurement window 04 is additionally illustrated.

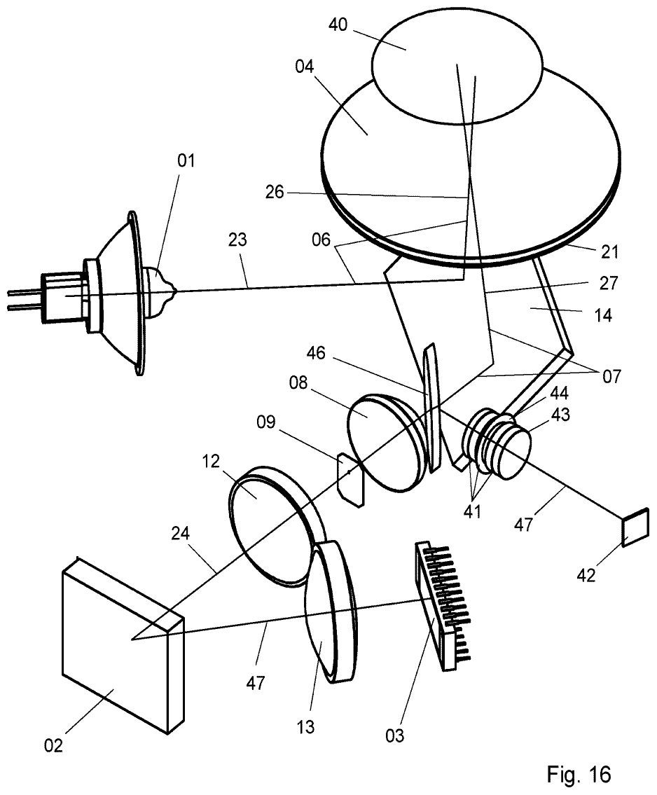

FIG. 16 shows the sixth preferred embodiment shown in FIG. 15 in a further view. This illustration reveals in particular how the camera partial beam path 47 is coupled out from the second inner beam path 07.

1. A spectrometer for the spectral analysis of a sample comprising:
a radiation source for irradiating the sample with electromagnetic radiation;
a dispersive element for the spatiospectral splitting of the electromagnetic radiation reflected by the sample;
a measurement window for transmitting the electromagnetic radiation generated by the radiation source to the sample and for transmitting the electromagnetic radiation reflected by the sample to the dispersive element, wherein the electromagnetic radiation generated by the radiation source passes on a first inner beam path from the radiation source to the measurement window, and wherein the electromagnetic radiation reflected by the sample passes on a second inner beam path from the measurement window to the dispersive element;
a spatially resolving detector for the wavelength-dependent conversion of the spatiospectrally split electromagnetic radiation; and
a deflection mirror arranged on the first inner beam path and on the second inner beam path and serving for jointly deflecting the first inner beam path and the second inner beam path.

2. The spectrometer as claimed in claim 1, wherein the deflection mirror is configured to deflect the first inner beam path and the second inner beam path by a deflection angle which is 90°.

3. The spectrometer as claimed in claim 1, wherein a first portion of the first inner beam path between the radiation source and the deflection mirror and also a first portion of the second inner beam path between the deflection mirror and the dispersive element are arranged jointly in a first plane.

4. The spectrometer as claimed in claim 3, wherein a second portion of the first inner beam path between the deflection mirror and the measurement window and also a second portion of the second inner beam path between the measurement window and the deflection mirror are arranged jointly in a second plane arranged perpendicular to the first plane.

5. The spectrometer as claimed in claim 1, wherein the deflection mirror is tiltable between a first tilt position and a second tilt position, wherein the deflection mirror is oriented in the first tilt position for the joint deflection of the first inner beam path and the second inner beam path, and wherein the deflection mirror is oriented in the second tilt position for a reflection of the electromagnetic radiation generated by the radiation source onto the dispersive element.

6. The spectrometer as claimed in claim 1, wherein the deflection mirror is arranged fixedly within the spectrometer, wherein the spectrometer furthermore comprises a movable reference carrier with at least one optical reference which is pivotable into the first inner beam path and into the second inner beam path between the deflection mirror and the measurement window.

7. The spectrometer as claimed in claim 1, wherein the deflection mirror is pivotable between a first pivot position and a second pivot position, wherein the deflection mirror is oriented in the first pivot position for forming the first inner beam path and the second inner beam path and is arranged between, on one side, a reference carrier with at least one optical reference and, on the other side, the radiation source and the dispersive element, and wherein the deflection mirror in the second pivot position releases a beam path from the radiation source to the reference carrier and a beam path from the reference carrier to the dispersive element.

8. The spectrometer as claimed in claim 7, wherein a first optical path length from the radiation source via the deflection mirror to the sample and back from the sample via the deflection mirror to the dispersive element and a second optical path length from the radiation source to the optical reference and back from the optical reference to the dispersive element are equal in length.

9. The spectrometer as claimed in claim 1, wherein the deflection mirror or the optical reference has an electrochromic layer.

10. The spectrometer as claimed in claim 1, wherein it comprises a housing, in which the radiation source, the dispersive element, the spatially resolving detector and the deflection mirror are arranged, wherein the measurement window forms a part of an upper side or of a lower side of the housing, and wherein the housing has a height which is at most 80 mm.

11. The spectrometer as claimed in claim 1, wherein it comprises a beam splitter and an image converter, wherein the beam splitter is arranged on the second inner beam path and splits a camera partial beam path out of the second inner beam path, which is directed onto the image converter.

12. The spectrometer as claimed in claim 11, wherein the beam splitter and the image converter are arranged in the housing.

13. The spectrometer as claimed in claim 11, wherein the beam splitter is arranged on the second inner beam path between the deflection mirror and the dispersive element.

14. The spectrometer as claimed in claim 11, wherein it comprises a camera lens arranged on the camera partial beam path between the beam splitter and the image converter.

15. The spectrometer as claimed in claim 14, wherein the image converter forming an image plane, the camera lens forming a lens plane, the beam splitter, the deflection mirror and an object plane parallel to the measurement window are arranged with respect to one another such that the Scheimpflug condition is complied with.
